(19) United States
(12) Patent Application Publication
(10) Pub. No.: US 2004/0257932 A1
(43) Pub. Date: Dec. 23, 2004

(54) Optical disk recording method and optical disk recording system

(76) Inventors: Katsuichi Osakabe, Hamamatsu-shi (JP); Tamotsu Homma, Hamamatsu-shi (JP)

Correspondence Address: HARNESS, DICKEY & PIERCE, P.L.C., P.O. BOX 828, BLOOMFIELD HILLS, MI, 48303, US

(21) Appl. No.: 10/797,710

(22) Filed: Mar. 10, 2004

(30) Foreign Application Priority Data
Mar. 11, 2003 (JP) P.2003-065709

(51) Int. Cl. G11B 5/09; G11B 7/00

(52) U.S. Cl. 369/47.5; 369/53.31

(57) ABSTRACT

A crosstalk amount of a rewritable optical disk at an optimum recording power is stored, then the data recorded on the rewritable optical disk are reproduced upon overwriting the data on the rewritable optical disk, then a crosstalk amount in a reproduced signal is detected, and then this crosstalk amount is compared with a reference crosstalk amount. Since the crosstalk amount has such a characteristic that such crosstalk amount is increased larger as a width of a pit is thickened, i.e., a recording power is increased higher, it is possible to detect a recording power value by comparing the crosstalk amounts. As a result, the crosstalk amounts of both data are compared with each other by utilizing this characteristic, and then the recording conditions such as an erasing power, the recording power, etc. are changed in response to the compared result to overwrite the data.

### BACKGROUND OF THE INVENTION

The present invention relates to an optical disk recording method and an optical disk recording system, for presuming recording conditions by reproducing old data recorded on the optical disk upon overwriting data on a rewritable optical disk, and then recording the data while applying the recording conditions in response to a reproduced signal.

As the rewritable optical disk, there are CD-RW, DVD−RW, DVD+RW, DVD-RAM, and so forth. The recording characteristics of these disks are different according to respective makers, and also different according to respective types even though the rewritable optical disk manufactured by the same maker is employed. Upon writing the data onto the rewritable optical disk, normally the optical disk recording system adjusts recording conditions, which permit to get the optimum recording quality, by detecting identification information of the rewritable optical disk (disk ID) recorded on the optical disk and deciding the optimum recording power value for the rewritable optical disk by virtue of OPC (Optimum Power Control: optimum recording power deciding operation), and then executes the data writing (for example, see Patent Literature 1).

Patent Literature 1

JP-A-11-7645

However, in the optical disk system set forth in Patent Literature 1, if the data are overwritten on the optical disk on which the data are recorded by other optical disk system and then such data are reproduced, there existed such a problem that a jitter is worsened and an error rate is increased.

The reasons for this are given as follows. That is, although the optical disk recording systems have different recording conditions according to respective makers or types, the optical disk system set forth in Patent Literature 1 records the data on the optical disk while correlating the device identification information of own system with the disk identification information of the rewritable optical disk. Therefore, in case the data are overwritten onto the optical disk on which the data have been recorded by another optical disk recording system, the optimum recording power value could not be obtained unless the OPC is applied. Even if the data are recorded after the optimum recording power value is detected by executing the OPC, in some cases the old data cannot be perfectly erased because the recording conditions are different from those of the optical disk recording system that is used to record the old data.

Since various settings such as a recording power, an erasing power, a bottom power, etc. of the laser beam being irradiated onto the rewritable optical disk are different according to respective makers or respective types, the optical disk recording systems exhibit following recording characteristics. FIGS. 1A and 1B are graphs showing a relationship between the number of overwrite times and the jitter of the rewritable optical disk and change in the jitter when the optical disk is overwritten at different recording powers. In this case, the case the data are overwritten successively onto the rewritable optical disk of the same type at the different recording powers is shown in FIGS. 1A and 1B. Magnitudes of the recording power are set as P2w<P0w<P1w, and P0w is an optimum recording power.

(1) The rewritable optical disk have different values of the jitter at the time of reproduction and the executable number of overwrite times in answer to the recording power of the irradiated laser beam. In other words, as shown in FIG. 1A, in case the rewritable optical disk is recorded at the optimum recording power P0w, the jitter is worsened for the first time, nevertheless such jitter is improved gradually as the number of overwrite times is increased. Then, the jitter is stabilized subsequently after the overwrite is almost 10 times carried out, and the jitter is worsened suddenly after the number of overwrite times is in excess of 1000. As a result, in case the rewritable optical disk is recorded at the optimum recording power P0w, the user can overwrite 1000 times that is the number of rewritable times defined in Orange Book Part 3.

In case the rewritable optical disk is recorded at the recording power P1w stronger than the optimum recording power P0w, the jitter is not worsened and stabilized even when the number of overwrite times is small, and the jitter is always improved in contrast to the optimum recording power P0w. However, degradation of the optical disk is accelerated, and the jitter is worsened suddenly at the number of overwrite times that is smaller than 1000 times. As a result, since a lifetime of the rewritable optical disk is shortened in case the rewritable optical disk is recorded at the recording power P1w, the user can overwrite only the times that are considerably smaller than 1000 times.

In contrast, in case the rewritable optical disk is recorded at the recording power P2w weaker than the optimum recording power P0w, similar characteristics to the case of the optimum recording power P0w are exhibited, nevertheless the jitter value is always worsened rather than the case of the optimum recording power P0w. The degradation of the optical disk is slowed down and the jitter is worsened when the overwrite is carried out 1000 times or more. As a result, since a lifetime of the rewritable optical disk is prolonged in case the rewritable optical disk is recorded at the recording power P2w, the user can overwrite in excess of 1000 times.

(2) In case the data are recorded on the rewritable optical disk at a certain recording power and then the data are overwritten at a different recording power, the jitter is changed. In other words, in the situation that the recording powers of the laser beam irradiated onto the optical disk are set in the relationship of P2w<P0w<P1w, as shown in FIG. 1B, the jitter is improved when the data are recorded on the rewritable optical disk at the recording power P2w and then are overwritten at the recording power P0w (>P2w). The jitter is not changed when the data are recorded on the rewritable optical disk at the recording power P0w and then are overwritten at the same recording power P0w. In contrast, the jitter is worsened when the data are recorded on the rewritable optical disk at the recording power P1w and then are overwritten at the recording power P0w (<P1w).

(3) In case the irradiated laser beam has the same spot shape, a width of a pit formed on the rewritable optical disk is widened when the recording power is enhanced. FIGS. 2A to 2C are views showing a pit shape formed on the rewritable optical disk. For example, in the situation that the recording powers of the laser beam irradiated onto the optical disk are set in the relationship of P2w<P0w<P1w, as shown in FIGS. 2A to 2C, a width of the pit is increased as the recording power is enhanced, and widths of respective pits have the relationship of W2<W0<W1. When erasing powers of the laser beam irradiated onto the optical disk are set in a relationship of P2e<P0e<P1e, an erasing area is widened as the erasing power is increased.

In examples shown in FIGS. 2A and 2C, the pit formed by irradiating the laser beam at the recording power P2w can be erased perfectly if the erasing power of the laser beam is set to P2e or more. That is, the pit can be erased at the erasing power of P2e, P0e, or P1e. The pit formed by irradiating the laser beam at the recording power P0w can be erased perfectly if the erasing power of the laser beam is set to P0e or more. That is, the pit can be erased at the erasing power of P0e or P1e, but such pit cannot be perfectly erased at the erasing power of P2e and its side end portions still remain. In addition, the pit formed by irradiating the laser beam at the recording power P1w can be erased perfectly if the erasing power of the laser beam is set to P1e or more. That is, the pit can be erased at the erasing power of P1e, but such pit cannot be perfectly erased at the erasing power of P2e or P0e and its side end portions still remain.

Accordingly, in case the rewritable optical disk is overwritten by the optical disk recording system different from the optical disk recording system used to record the old data, following phenomena are produced. FIGS. 3A and 3B are image views showing situations when the rewritable optical disk is overwritten. That is, as shown in FIG. 3A, in case the rewritable optical disk is recorded at the recording power P2w and then the data are overwritten by irradiating the laser beam at the erasing power P0e and the recording power P0w (>P2w), the original pit formed by irradiating the laser beam at the recording power P2w can be perfectly erased by the laser beam at the erasing power P0e. Therefore, the pit formed at the recording power P2w never remains. When the pit is formed by irradiating the laser beam at the recording power P0w, the jitter is excellent when the laser beam is irradiated at the recording power P0w, as shown in FIG. 1B. Therefore, the jitter is improved and the error rate is lowered.

In contrast, as shown in FIG. 3B, in case the rewritable optical disk is recorded at the recording power P1w and then is overwritten by irradiating the laser beam at the erasing power P0e and the recording power P0w (<P1w), the original pit formed by irradiating the laser beam at the recording power P1w cannot be perfectly erased by irradiating the laser beam at the erasing power P0e and its side end portions still remain. This is because such laser beam at the erasing power P0e has a narrow erasing area. Since the pit formed by irradiating the laser beam at the recording power P0w has a narrower width than the pit formed by irradiating the laser beam at the recording power P1w, overlapped portions between side end portions of the original pit and a newly formed pit are formed. As a consequence, the jitter is worsened and the error rate is increased.

An optical disk recording system of a maker or of a moded type has its own setting of a write strategy. FIG. 4 is an example of the write strategy of the rewritable optical disk. In addition, normally the laser power of the rewritable optical disk is controlled by setting the write strategy. In this case, when a version of the firmware is modified, the writing power Pw, the erasing power Pe, and the bottom power Pb are varied simultaneously, or any of them is varied. In this manner, if at least any one of the writing power Pw, the erasing power Pe, or the bottom power Pb is varied, the previously recorded data cannot be perfectly erased and end portions of the pit still remain even in the same optical disk recording system. Thus, the jitter is worsened and the error rate is increased.

The spot shape of the laser beam that the optical disk recording system irradiates onto the optical disk is different according to respective makers of the optical disk recording system. FIGS. 5A to 5D are views showing a spot shape of the laser beam from the optical disk recording system and a pit shape formed on the rewritable optical disk. As shown in FIGS. 5A to 5D, in case the rewritable optical disk is CD-RW, the spot shape of the optical disk recording system is set to a laterally-long ellipse, a vertically-long ellipse, and an obliquely-long ellipse in the spot proceeding direction in the systems manufactured by A company, B company, and C company respectively. In case the rewritable optical disk is DVD−RW, DVD+RW, or DVD-RAM, a circle, a vertical ellipse, a lateral ellipse, and an oblique ellipse are present as the spot shape of the optical disk recording system.

In this fashion, since the spot shape of the laser beam is different, a shape (width) of the pit formed on the rewritable optical disk becomes different according to respective makers of the optical disk recording system, as shown in FIGS. 5A to 5D. Therefore, in case the data are overwritten on the rewritable optical disk, on which the data are recorded by the optical disk recording system of a certain maker, by the optical disk recording system of another maker, the same phenomenon as that explained with reference to FIG. 3B occurs even though the recording power and the erasing power are set to the identical values respectively. In other words, in case the data are recorded on the rewritable optical disk D by irradiating the laser beam having the spot shape shown in FIG. 5A and then the data are overwritten by irradiating the laser beam having the spot shape shown in FIG. 5B, end portions of the old pit are not erased and still remain. Therefore, the jitter is worsened and the error rate is increased. On the contrary, in case the data are recorded on the rewritable optical disk D by irradiating the laser beam having the spot shape shown in FIG. 5B and then the data are overwritten by irradiating the laser beam having the spot shape shown in FIG. 5A, the old pit can be perfectly erased. Therefore, the jitter is improved and the error rate is decreased.

In the optical disk recording system, normally the pit having the same width (shape) can be formed after the recording speed is changed, and the recording power and the erasing power are set to perfectly erase the old data when the data are overwritten. However, the width (shape) of the formed pit becomes different owing to variation in the material of the laser diode or the rewritable optical disk when the recording speed is different. For this reason, in some cases the pit formed previously cannot be perfectly erased when the data are overwritten. For example, when the data are overwritten at the standard speed on the rewritable optical disk on which the data are recorded at the quadruple speed, the pit recorded at the quadruple speed cannot be perfectly erased, so that sometimes the jitter is worsened and the error rate is increased.

As described above, in the optical disk recording system in the related art, recording conditions such as the recording power, the erasing power, the bottom power, the write strategy, the spot shape, etc. of the laser beam, which is to be irradiated onto the rewritable optical disk, are different according to the maker, the model type, the version of the firmware, the recording speed, etc. The rewritable optical disk has the different recording characteristics in accordance with the recording conditions. Therefore, in case the data are overwritten on the rewritable optical disk on which the data are recorded by a certain optical disk recording system by another optical disk recording system, neither the pit formed on the rewritable optical disk can be perfectly erased nor the new pit can be formed to cover the old pit. As a result, the jitter is worsened and the error rate is increased.

### SUMMARY OF THE INVENTION

Therefore, it is an object of the present invention to provide an optical disk recording method and an optical disk recording system capable of recording the data not to worsen a jitter and to get a low error rate even when a rewritable optical disk that is recorded by a certain optical disk recording system is overwritten by another optical disk recording system.

To overcome the above problems, the present invention has following configurations.

(1) An optical disk recording method comprising the steps of:

deriving a recording condition of old data recorded on a rewritable optical disk by reproducing the old data or from a reproduced waveform;

deciding an overwriting recording condition to overwrite new data on the old data recorded under the recording condition of the old data; and

overwriting the new data on the old data according to the decided overwriting recording condition.

(2) The optical disk recording method according to (1), wherein the recording condition of the old data is derived upon an instruction to overwrite the new data on old data recorded on the rewritable optical disk.

(3) An optical disk recording method comprising the steps of:

detecting a crosstalk amount from a reproduced waveform of old data recorded on a rewritable optical disk;

setting a recording condition based on the detected crosstalk amount; and

overwriting new data according to the recording condition.

(4) The optical disk recording method according to (3), wherein the crosstalk amount is detected upon an instruction to overwrite the new data on old data recorded on the rewritable optical disk.

(5) The optical disk recording method according to (3), wherein the recording condition is set in response to a difference between the detected crosstalk amount and a reference crosstalk amount.

(6) The optical disk recording method according to (5), wherein an optimum recording power is decided by applying a trial writing onto a trial writing area of the rewritable optical disk, and the reference crosstalk amount is detected based on a reproduced waveform of data that are recorded at the optimum recording power.

(7) An optical disk recording method comprising the steps of:

acquiring a peak-to-peak value of a reproduced signal of old data recorded on a rewritable optical disk;

setting a recording condition based on the peak-to-peak value; and

overwriting new data according to the recording condition.

(8) The optical disk recording method according to (7), wherein the peak-to-peak value is acquired upon an instruction to overwrite the new data on old data recorded on the rewritable optical disk.

(9) The optical disk recording method according to (7), wherein an optimum recording power is decided by applying a trial writing onto a trial writing area of the rewritable optical disk, and the recording condition is set in response to a difference between the peak-to-peak value of the amplitude of the reproduced signal of data recorded at the optimum recording power and the peak-to-peak value of the amplitude of the reproduced signal of the old data.

(10) An optical disk recording method comprising the steps of:

applying a trial writing while changing a laser power irradiated onto a trial writing area of a rewritable optical disk by a predetermined amount;

deciding an optimum recording power based on a reproduced signal of trial-written data;

acquiring a first peak-to-peak value based on a peak value and a bottom value of a reproduced signal of data recorded at the optimum recording power;

acquiring a second peak-to-peak value based on a peak value and a bottom value of a reproduced signal of old data recorded on the rewritable optical disk; and

correcting an erasing power of a laser beam irradiated onto the rewritable optical disk in response to a difference between the first and second peak-to-peak values, and overwriting the new data by applying a corrected erasing power.

(11) The optical disk recording method according to (10), wherein the trial writing is applied upon an instruction to overwrite the new data on old data recorded on the rewritable optical disk.

(2) An optical disk recording system comprising:

a reproducing unit which reproduces data recorded on a rewritable optical disk;

a crosstalk detecting unit which detects a crosstalk amount from a reproduced waveform of the reproducing unit;

a recording-condition setting unit which sets a recording condition based on the crosstalk amount detected by the crosstalk detecting unit; and

a recording unit which overwrites new data on old data according to the recording condition set by the recording-condition setting unit.

(13) An optical disk recording system comprising:

a reproducing unit which reproduces data recorded on a rewritable optical disk;

an envelope detecting unit which acquires a peak-to-peak value of a reproduced signal of the reproducing unit;

a recording-condition setting unit which sets a recording condition based on the peak-to-peak value acquired by the envelope detecting unit; and

a recording unit which overwrites new data on old data according to the recording condition set by the recording-condition setting unit.

### BRIEF DESCRIPTION OF THE DRAWINGS

FIGS. 1A and 1B are graphs showing a relationship between the number of overwrite times and a jitter of a rewritable optical disk and change in the jitter when the optical disk is overwritten at different recording powers.

FIGS. 2A to 2C are views showing a pit shape formed on the rewritable optical disk.

FIGS. 3A and 3B are image views showing situations when the rewritable optical disk is overwritten.

FIG. 4 is an example of a write strategy of the rewritable optical disk.

FIGS. 5A to 5D are views showing a spot shape of a laser beam from an optical disk recording system and a pit shape formed on the rewritable optical disk.

FIG. 6 is a block diagram showing a configuration of an optical disk recording system according to an embodiment of the present invention.

FIG. 7 is a sectional view showing an area structure of the optical disk.

FIGS. 8A and 8B are schematic views showing a relationship between a recording area and a reproduced spot.

FIG. 9 are a block diagram showing details of a crosstalk detecting circuit.

FIGS. 10A and 10B are waveform diagrams showing a signal being output when an optical pickup is moved and a definition of a crosstalk amount.

FIG. 11 is a flowchart explaining an operation of detecting the crosstalk amount in an optical disk recording system according to a first embodiment.

FIGS. 12A to 12C are views showing pits recorded at different recording powers and reproduced waveforms of respective pits.

FIGS. 13A to 13C are Reproduced signal patterns in which 3T to 11T pits recorded under conditions shown in FIG. 12A are reproduced.

FIG. 14 is a block diagram showing details of an envelope detecting circuit.

FIG. 15 is a flowchart explaining an operation of detecting a PP value in an optical disk recording system according to a second embodiment.

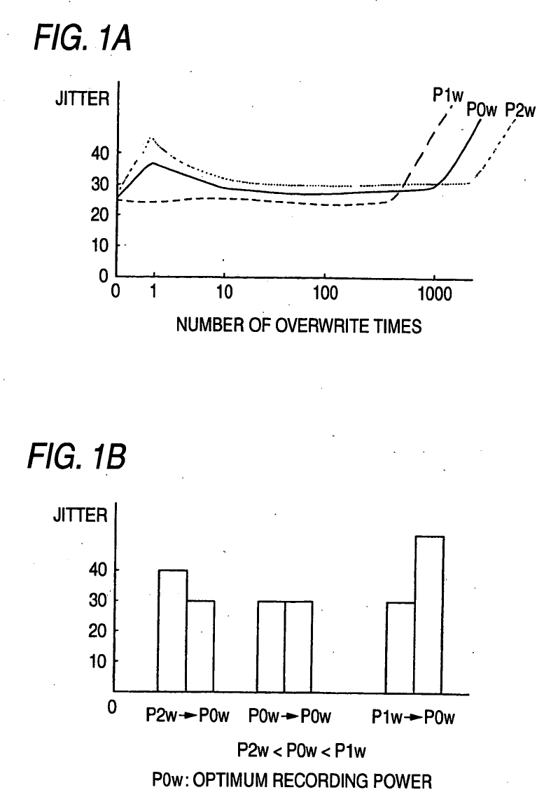

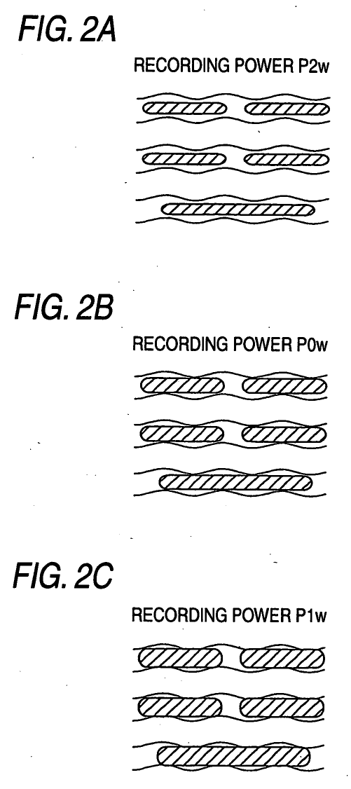

### DETAILED DESCRIPTION OF PREFERRED EMBODIMENTS

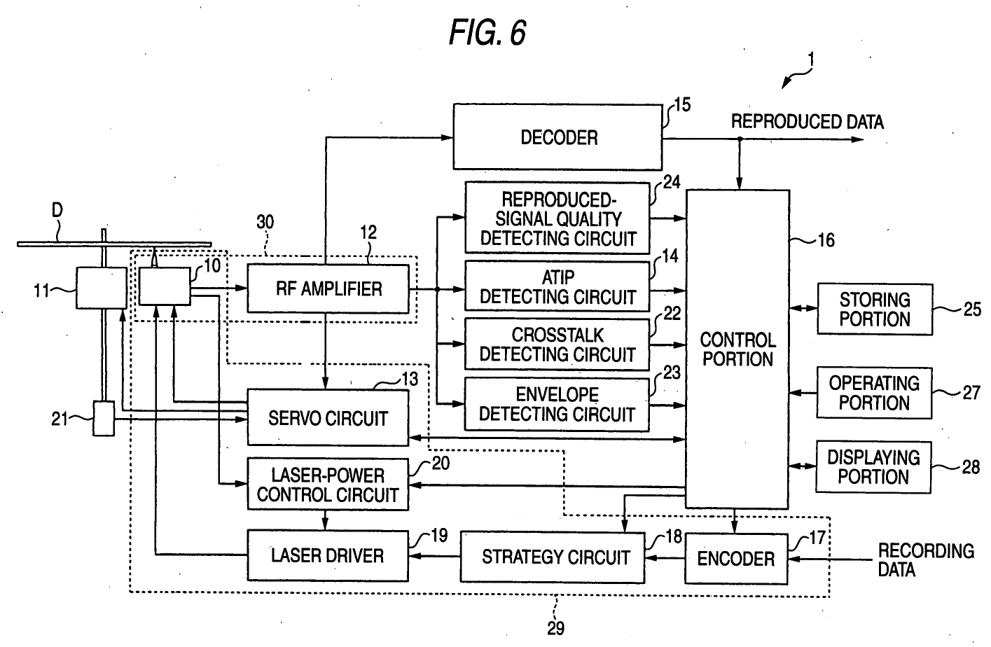

Explanation will be made with the case where data are overwritten on the CD-RW as an example of the rewritable optical disk in the following. First, details of an optical disk recording system according to an embodiment of the present invention will be explained. FIG. 6 is a block diagram showing a configuration of the optical disk recording system according to the embodiment of the present invention. In the present embodiment, such a configuration is shown that the laser beam is used as the light beam being irradiated onto the optical disk. As shown in FIG. 6, an optical disk recording system 1 includes an optical pickup 10, a spindle motor 11, an RF amplifier 12, a servo circuit 13, an ATIP detecting circuit 14, a decoder 15, a control portion 16, an encoder 17, a strategy circuit 18, a laser driver 19, a laser-power control circuit 20, a frequency generator 21, a crosstalk detecting circuit 22, an envelope detecting circuit 23, a reproduced-signal quality detecting circuit 24, a storing portion 25, an operating portion 27, and a displaying portion 28. A recording portion 29 as a data recording unit is constructed with the optical pickup 10, the servo circuit 13, the encoder 17, the strategy circuit 18, the laser driver 19, and the laser-power control circuit 20. In addition, a reproducing portion 30 as a data reproducing unit is constructed with the optical pickup 10 and the RF amplifier 12.

The spindle motor 11 is a motor for rotating/driving the optical disk D as a target for data recording. An optical disk holding mechanism (not shown) such as a turn table, or the like for holding (chucking) the optical disk is provided to a top end portion of a rotating shaft of the spindle motor.

The optical pickup 10 includes a laser diode, an optical system such as a lens, a mirror, etc., a return light (reflected light) receiving element, and a focus servo mechanism, and so forth. Upon recording and reproducing, the laser beam is irradiated onto the optical disk D, then the return light from the optical disk D is received, and an RF signal as the received light signal that is subjected to EFM (Eight to Fourteen Modulation) is output to the RF amplifier 12. In this case, the focus servo mechanism is a servo mechanism that maintains a distance between a lens of the optical pickup 10 and a data surface of the optical disk constant. The optical pickup 10 has a monitor diode. An electric current is generated in the monitor diode by the return light from the optical disk D, and this electric current is supplied to the laser-power control circuit 20.

The frequency generator 21 detects a rotation angle or the number of rotation being output from the spindle motor 11, and then outputs the signal to the servo circuit 13.

The RF amplifier 12 amplifies the EFM-modulated RF signal supplied from the optical pickup 10, and then outputs the amplified RF signal to the servo circuit 13, the ATIP detecting circuit 14, the crosstalk detecting circuit 22, the envelope detecting circuit 23, the reproduced-signal quality detecting circuit 24 for measuring the quality of the reproduced signal, and the decoder 15.

In the reproducing operation, the decoder 15 EFM-demodulates the EFM-modulated RF signal supplied from the RF amplifier 12 to produce reproduced data, and then outputs the data to the storing portion 25. In the recording operation, the decoder 15 EFM-demodulates the RF signal supplied from the RF amplifier 12 at the time of reproducing the area in which the data is recorded by the test recording.

In the optical disk recording system 1 according to the present embodiment, upon recording the data, a test recording is applied to a PCA (Power Calibration Area) area on the inner peripheral side of the optical disk D prior to the normal data recording. Then, recording conditions that permit the good recording onto the optical disk are produced based on the reproduced result of this test recording area.

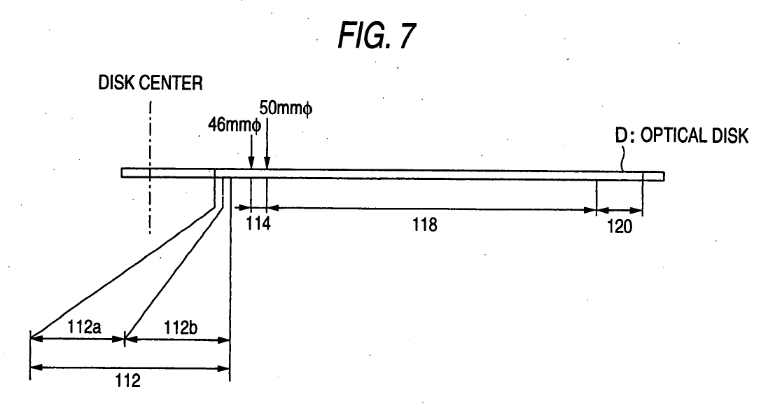

Now, the area of the optical disk D, in which the test recording is applied, will be explained with reference to FIG. 7 hereunder. FIG. 7 is a schematic view showing an area structure of the optical disk. An outer diameter of the optical disk D is 120 mm. A 46-50 mm section of the optical disk D along its diameter is prepared as a lead-in area 114, and a program area 118 for recording the data and a remaining area 120 are prepared on the outer peripheral side of the lead-in area 114. In contrast, an inner-peripheral side PCA area 112 is prepared on the inner peripheral side of the lead-in area 114. A test area 112a and a count area 112b are prepared in the inner-peripheral side PCA area 112. As described above, the test recording is applied to the test area 112a prior to the normal recording. Here, an area to which the test recording may be applied plural times is prepared as the test area 112a . The EFM signal indicating up to which portion of the test area 112a the recording is finished at the end of the test recording is recorded on the count area 112b. Accordingly, upon applying the test recording to the optical disk D next time, it is found by detecting the EFM signal in the count area 112b from which position of the test area 112a the test recording should be started. In the optical disk recording system 1 of the present embodiment, the test recording is applied to the above test area 112a before the normal data recording is carried out.

Returning to FIG. 6, the storing portion 25 stores once the reproduced data of the optical disk D output from the decoder 15, the data being input from the outside of the optical disk recording system 1, and so on. Then, the stored data are output to a data reproducing portion (not shown) at the time of playing, while the stored data are output to the encoder 17 when the data are recorded onto the recording optical disk.

The ATIP detecting circuit 14 extracts a wobble signal component contained in the RF signal that is supplied from the RF amplifier 12, then decodes time information of respective positions (address information) contained in this wobble signal component, identification information (disk ID) for identifying the optical disk, and information indicating the disk type such as a pigment used in the disk, and then outputs the information to the control portion 16. Here, the wobble signal component unit a signal component representing a wobbling frequency of a wobbled recording track of the recording optical disk. The time information, the identification information, etc. are recorded by FM-modulating the wobbling frequency.

The crosstalk detecting circuit 22 reproduces the data recorded on the optical disk and, as the case may be, detects an amount of signal (a crosstalk amount) from the adjacent track while rotating the disk. This crosstalk amount is changed according to a track pitch and a pit width (shape).

In order to detect from which portion of the test area 112a of the optical disk D the test recording should be started before the test recording is applied to the optical disk D, the envelope detecting circuit 23 detects an envelope of the EFM signal in the above count area 112b of the optical disk D.

The reproduced-signal quality detecting circuit 24 calculates a β value and asymmetry, which are associated with the quality of the reproduced signal, based on the RF signal supplied from the RF amplifier 12 while the test recording area of the optical disk D is reproduced, and then outputs calculated results to the control portion 16. Where the β value can be calculated by β=(a+b)/(a−b), where a is a peak level (a sign is +) of a signal waveform that is subjected to the EFM modulation, and b is a bottom level (a sign is −) thereof.

The servo circuit 13 executes rotation control of the spindle motor 11, and focus control, tracking control, and feed control of the optical pickup 10. In the optical disk recording system 1 according to the present embodiment, a CAV (Constant Angular Velocity) system as a system for driving the optical disk D at a constant angular velocity and a CLV (Constant Linear Velocity) system as a system for driving the optical disk D at a constant linear velocity may be switched at the time of recording. Therefore, the servo circuit 13 switches the CAV system and the CLV system in response to the control signal supplied from the control portion 16. Now, in the CAV control made by the servo circuit 13, the number of rotation of the spindle motor 11 detected by the frequency generator 21 is controlled so as to coincide with the set number of rotation. In the CLV control made by the servo circuit 13, the spindle motor 11 is controlled such that a wobble signal in the RF signal supplied from the RF amplifier 12 is set to a velocity multiple.

The encoder 17 EFM-modulates the recorded data supplied from the storing portion 25, and then output the data to the strategy circuit 18. The strategy circuit 18 applies a time base correcting process, etc. to the EFM signal supplied from the encoder 17, and then outputs the resultant signal to the laser driver 19. The laser driver 19 drives the laser diode in the optical pickup 10 in compliance with the signal modulated in reply to the recorded data supplied from the strategy circuit 18 and the control of the laser-power control circuit 20.

The laser-power control circuit 20 controls a laser power irradiated from the laser diode in the optical pickup 10. More particularly, the laser-power control circuit 20 controls the laser driver 19 in such a way that the laser beam of an optimum laser power should be irradiated from the optical pickup 10, based on a current value supplied from the monitor diode in the optical pickup 10 and information indicating a target value of the optimum laser power supplied from the control portion 16.

The control portion 16 is composed of CPU, ROM, RAM, and so forth, and controls respective portions of the optical disk recording system 1 in accordance with a program stored in the ROM. The control portion 16 controls respective portions of the system so as to apply the test recording to a predetermined area of the optical disk DDD being set in the optical disk recording system 1 prior to the normal data recording, as described above. Then, in the control portion 16, a recording speed deciding process of deciding a recordable speed that permits the good recording without a recording error, etc. are applied to the optical disk D to which the test recording has already been applied by the optical disk recording system 1, by detecting relationships between the quality of the reproduced signal and system recording parameters (recording conditions) such as a target β value, a write strategy, etc. based on the quality of the reproduced signal such as the β value,or the like that is detected by the reproduced-signal quality detecting circuit 24 from the signal obtained by reproducing the above test recorded area.

The storing portion 25 stores a reference crosstalk amount CT0 every model type of the rewritable optical disk. The operating portion 27 is provided to execute an operation to record the data onto the optical disk. The displaying portion 28 is provided to display contents such as operation contents executed by the operating portion 27, which should be transferred to the user.

First Embodiment

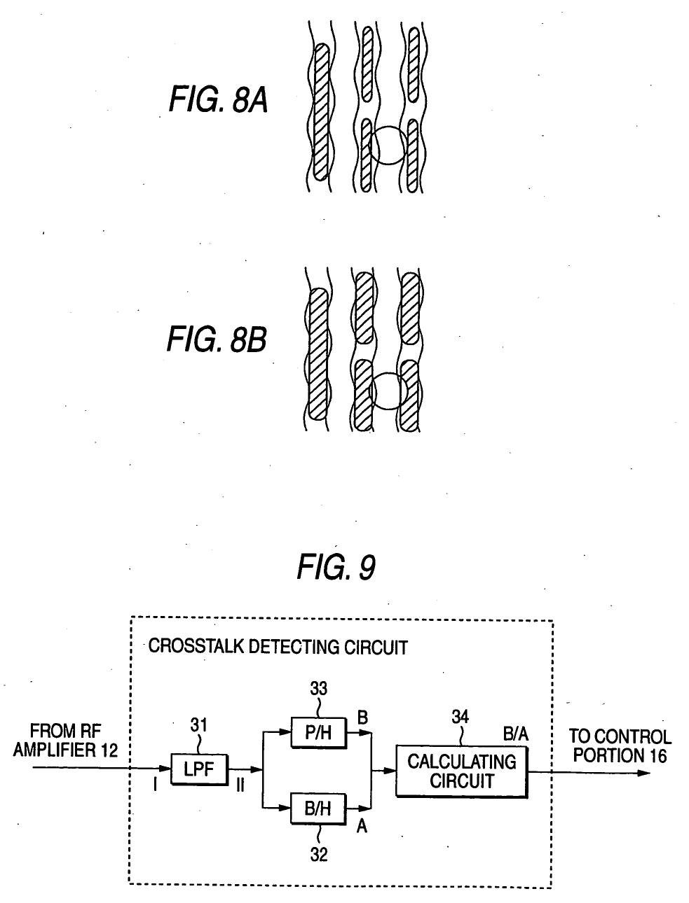

Next, the optical disk recording system according to the first embodiment of the present invention will be explained hereunder. FIGS. 8A and 8B are schematic views showing a relationship between a recording area and a reproduced spot, wherein FIG. 8A shows a relationship between the area which is recorded at an optimum recording power and the reproduced spot, and FIG. 8B shows a relationship between the area which is recorded at a power higher than the optimum recording power and the reproduced spot. As shown in FIG. 8A, when the data are recorded at the optimum recording power, the width of the pit (the portion in which the recording layer is brought into an amorphous state by irradiating the laser beam onto the rewritable optical disk) is formed properly. Therefore, since the influence exerted by the pit when the spot is positioned on the land is small, a reduction in a signal level of the reflected light is small. In case the data are recorded at the optimum recording power in this manner, the influence (a crosstalk amount) is seldom exerted by other tracks during the reproduction of a certain track. In contrast, as shown in FIG. 8B, in case the data are recorded at a higher power than the optimum recording power, the width of the pit is thickened. Therefore, since the spot is more affected by the pit when such spot is positioned on the land, the signal level of the reflected light is further reduced. In this manner, in the rewritable optical disk, the width of the pit becomes different according to the recording power and a crosstalk amount is different correspondingly.

Therefore, in the optical disk recording system according to the first embodiment of the present invention, a crosstalk amount generated at the optimum recording power of the rewritable optical disk is stored previously, then such crosstalk amount in the reproduced signal is detected by reproducing the data recorded onto the rewritable optical disk when the data are to be overwritten on the rewritable optical disk, and then this crosstalk amount is compared with a reference crosstalk amount. As described above, since a crosstalk amount has such a characteristic that the crosstalk amount is increased as the width of the pit is thickened, i.e., the recording power is enhanced, it is feasible to detect the recording power value by comparing crosstalk amounts mutually. In the optical disk recording system according to the first embodiment of the present invention, crosstalk amounts of both data are compared with each other by utilizing this characteristic, and then the recording conditions such as the erasing power, the recording power, and so forth are changed (e.g., they are changed into the same recording conditions as those of the optical disk recording system by which the old data are recorded) in response to the compared result to overwrite the data. Consequently, the old data can be perfectly erased when the data are overwritten by the optical disk recording system that is different from the optical disk recording system by which the old data are recorded, and therefore degradation of the jitter can be prevented and the error rate can be decreased.

As the recording conditions that are changed based on the compared result of a crosstalk amount, upon overwriting the data onto the rewritable optical disk, the erasing power of the laser beam that the optical disk recording system irradiates onto the rewritable optical disk may be changed such that the old data being subjected to the overwrite can be erased without fail. The data may be overwritten (erased and recorded) like the original optical disk recording system by changing the conditions such as the recording power, the bottom power (bias power), ε (erasing power/recording power), the write strategy, a correction value of the recording power obtained by OPC, etc.

In this case, in case the recording power of the optical disk recording system used to record the old data is weaker than the recording power of the optical disk recording system used to overwrite the data, or the like, the erasing power and the recording power must be increased. Thus, degradation of the rewritable optical disk and the laser diode in the optical disk recording system 1 is accelerated. Therefore, in such case, upon overwriting the data on the rewritable optical disk, the erasing power of the laser beam being irradiated onto the rewritable optical disk may be increased in response to a crosstalk amount of the old data, and then the data may be overwritten by using the value, which is set in the optical disk recording system as its own initial value, without change of the recording power. Accordingly, the degradation of the rewritable optical disk and the laser diode in the optical disk recording system 1 can be suppressed.

In case the recording power of the optical disk recording system used to overwrite the data is stronger than the recording power of the optical disk recording system used to record the old data, or the like, the data maybe overwritten at the initial the erasing power and the recording power without changing initial values

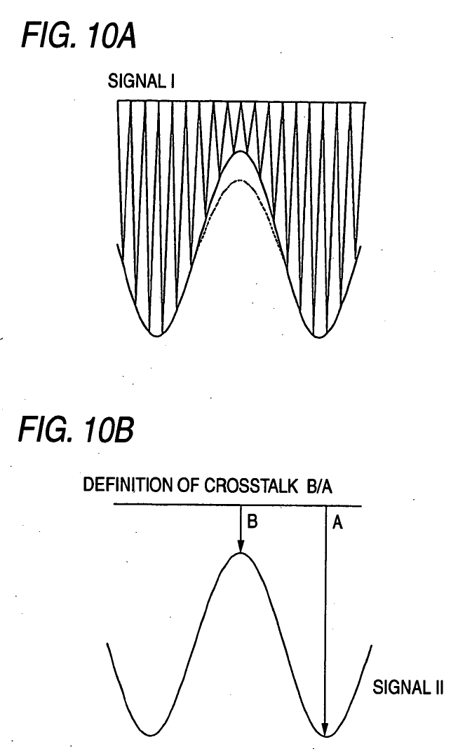

FIG. 9 is a block diagram showing details of the crosstalk detecting circuit. FIGS. 10A and 10B are waveform diagrams showing a signal being output when the optical pickup is moved and a definition of a crosstalk amount. In the optical disk recording system 1, as described above, a crosstalk amount is detected by the crosstalk detecting circuit 22. As shown in FIG. 9, the crosstalk detecting circuit 22 is constructed by a low-pass filter (LPF) 31, a bottom hold circuit (B/H) 32, a peak hold circuit (P/H) 33, and a calculating circuit 34.

The low-pass filter 31 cuts off a high frequency component in the signal output from the RF amplifier 12, and outputs a low frequency component to the bottom hold circuit 32 and the peak hold circuit 33. The bottom hold circuit 32 holds a bottom value A of the signal output from the low-pass filter 31 and outputs it. The peak hold circuit 33 holds a peak value B of the signal output from the low-pass filter 31 and outputs it. The calculating circuit 34 executes an operation by using the bottom value A output from the bottom hold circuit 32 and the peak value B output from the peak hold circuit 33 to calculate a crosstalk amount.

In the crosstalk detecting circuit 22, processes described in the following are carried out. When the optical pickup is moved while turning the optical disk, a signal I is output from the RF amplifier 12, as shown in FIG. 10A. The signal I is a signal whose level is lowered in the pit portion in which a reflectance is low with regard to a mirror level. The pit signal (EFM) is a high frequency signal. A bottom level of the pit signal is increased/decreased at a repetition period of the land and the groove, and increase/decrease of level appears at a predetermined period on its envelope signal. The envelope indicated by a solid line in FIG. 10A gives an envelope obtained when the portion that is recorded at the optimum recording power is reproduced, while the envelope indicated by a dotted line in FIG. 10A gives an envelope obtained when the portion that is recorded at the high power is reproduced.

The signal I output from the RF amplifier 12 is changed into a signal II shown in FIG. 9 after the signal passes through the low-pass filter 31. The signal II is a lower envelope signal of the signal I, and is at a lowermost level in the groove and is at an uppermost level on the land. The bottom hold circuit 32 bottom-holds the lowermost level of the signal II output from the low-pass filter 31 as the A level and acquires it. The peak hold circuit 33 peak-holds the uppermost level of the signal II output from the low-pass filter 31 as the B level and acquires it. The calculating circuit 34 executes an operation B/A by using the bottom value A output from the bottom hold circuit 32 and the peak value B output from the peak hold circuit 33 to calculate a crosstalk level.

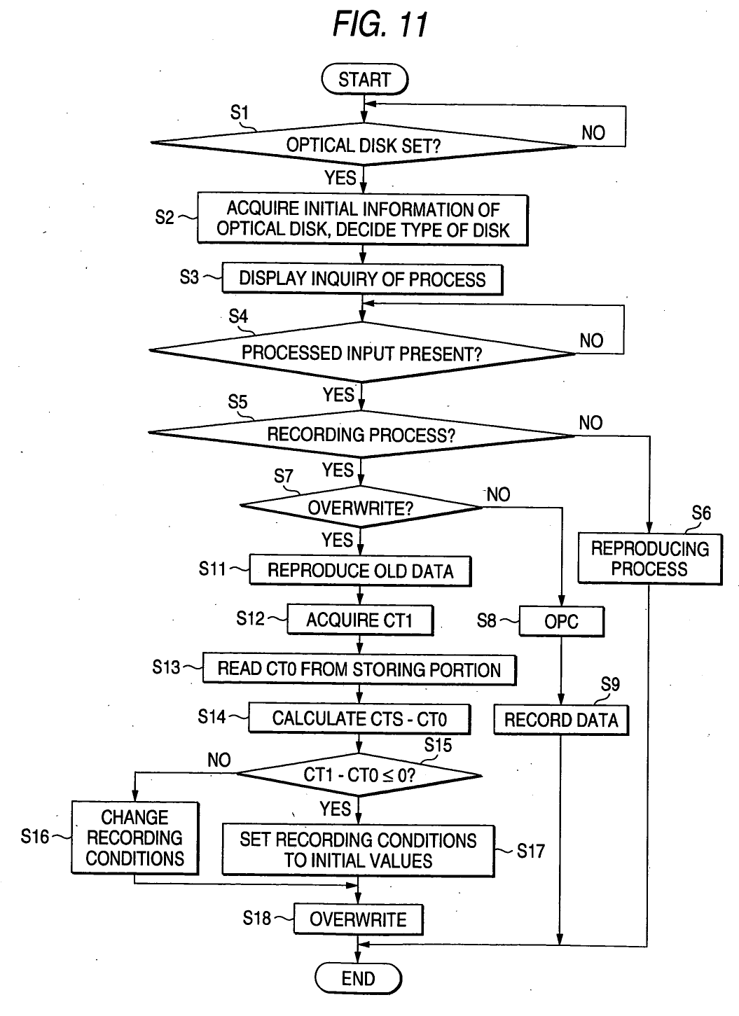

In the optical disk recording system 1, processes described in the following are carried out to overwrite the data on the rewritable optical disk. FIG. 11 is a flowchart explaining an operation of detecting a crosstalk amount in the optical disk recording system according to the first embodiment.

First, the user sets CD-RW on the disk tray of the optical disk recording system 1 in case the data are recorded on the CD-RW. The control portion 16 of the optical disk recording system 1 detects that the optical disk is set (s1), then chucks the CD-RW, then moves the optical pickup up to a predetermined location, and then acquires initial information of the optical disk by irradiating the laser beam (s2). More particularly, first the control portion 16 decides a reflectance of the laser beam to identify the type of the optical disk. At this time, it is possible to decide that the optical disk is the rewritable optical disk (CD-RW) if the reflectance of the optical disk is low, while the optical disk is the write once optical disk (CD-R) or the read only (non-recordable) optical disk (CD-ROM) if the reflectance of the optical disk is high. The control portion 16 detects whether or not a wobble component is present in the lead-in area of the optical disk being set in the optical disk recording system 1, and detects ATIP information when the wobble information is present. The optical disk is decided as the rewritable or write once optical disk if the ATIP information are detected, and then the information such as disk ID (maker code), STLI (Start Time of Lead-In Area: equivalent to the maker code and the disk code), etc. contained in the ATIP information are utilized in various controls. In this manner, the control portion 16 decides which one of the rewritable, write once, and read only optical disks the optical disk corresponds to, based on the reflectance and the ATIP information. The control portion 16 acquires the disk ID of the optical disk from the ATIP information.

Then, the control portion 16 displays the contents inquiring the processes applied to the CD-RW that is set by the user, on the display portion 28 (s3). The user inputs the processes that are to be applied to the set CD-RW, in answer to this display. If the control portion 16 detects the input from the operating portion 27 (s4) and if reproduction of the data is set (s5), such control portion 16 carries out the data reproducing process (s6). The control portion 16 ends the process when the reproduction of the data is completed.

In contrast, if recording of the data is set (s5), the control portion 16 decides that the recording operation is either the initial recording or the overwriting (s7). More specifically, the control portion 16 decides whether or not the EFM signal is present in the lead-in area and PMA, and then decides such recording operation as the initial recording if the EFM signal is not recorded in both areas or the lead-in area. In case the CD-RW is a blank disk or in the course of recording, the data are recorded for the first time in an unrecorded area of the optical disk D. Thus, the control portion 16 decides the optimum recording power by executing the OPC in PCA (s8). Then, the control portion 16 records the data or writes once the data on the CD-RW (s9), and then ends the process.

In contrast, in step s7, if the EFM signal is recorded in the lead-in area and the PMA of the CD-RW, the control portion 16 decides that the overwriting should be executed and then reproduces the old data recorded on the rewritable optical disk (s11). If the control portion 16 acquires a crosstalk amount CT1 of the data recorded on the rewritable optical disk from the crosstalk detecting circuit 22 (s12), such control portion 16 reads a reference crosstalk amount CT0 from the storing portion 25 (s13). Then, the control portion 16 calculates CT1−CT0 (s14). If the calculated result is in excess of 0, the control portion 16 changes the recording conditions. For example, the control portion 16 executes the correction by multiplying the reference erasing power P0e and the reference recording power P0w by CT1/CT0 and a predetermined enumeration, and then sets these correction values (s16). Then, the control portion 16 overwrites the data on the rewritable optical disk at the corrected erasing power and the corrected recording power (s18), and then ends the process when the data recording is completed.

In contrast, if the calculated result of CT1−CT0 is less than 0 (s15), the control portion 16 sets the recording conditions to the initial values being set in the optical disk recording system 1. In other words, the control portion 16 sets the erasing power and the recording power to the reference erasing power P0e and the reference recording power P0w (s17), then overwrites the data on the rewritable optical disk (s18), and then ends the process when the data recording is completed.

Here, as described above, the reference crosstalk amount CT0 may be recorded in the storing portion 25 every model type of the rewritable optical disk. The reference crosstalk amount CT0 may be calculated as follows. That is, upon overwriting the data by the optical disk recording system, the optimum recording power is decided by executing the OPC, then the test data recorded at this optimum recording power is reproduced to calculate a value of the crosstalk amount, and then this value is set as the reference crosstalk amount CT0. Then, as described above, a crosstalk amount CT1 of the data may be detected by reproducing the old data recorded on the rewritable optical disk, and then the recording conditions may be decided in response to a difference between CT1−CT0. If doing this, a time required to decide the recording conditions is slightly increased, nevertheless the optimum recording conditions for the rewritable optical disk can be decided quickly without update of the firmware, etc. even though such rewritable optical disk is the newly sold one.

Second Embodiment

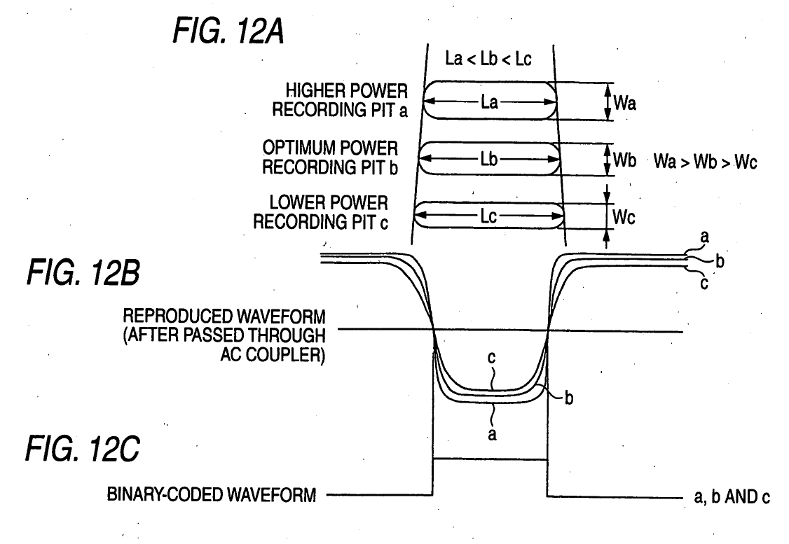

Next, an optical disk recording system according to a second embodiment of the present invention will be explained hereunder. FIGS. 12A to 12C are views showing pits recorded at different recording powers and reproduced waveforms of respective pits. In FIG. 12A, a pit a is a pit that is recorded at a recording power higher than the optimum recording power by a strategy shorter than the optimum strategy. A pit b is a pit that is recorded at the optimum power recording by the optimum strategy. A pit c is a pit that is recorded at a recording power lower than the optimum recording power by a strategy longer than the optimum strategy. As shown in FIG. 12A, widths of the pit a, the pit b, and the pit c have the relationship of Wa>Wb>Wc, and lengths of the pit a, the pit b, and the pit c have the relationship of La<Lb<Lc. As shown in FIG. 12B, when respective pits are reproduced, a peak-to-peak value (abbreviated as a “PP value” hereinafter) of the resultant reproduced signal is increased larger in connection with a size of a reproduced beam spot as the width of the pit becomes thicker. However, as shown in FIG. 12C, when respective reproduced signals are binary-coded, all of them can give the same signal.

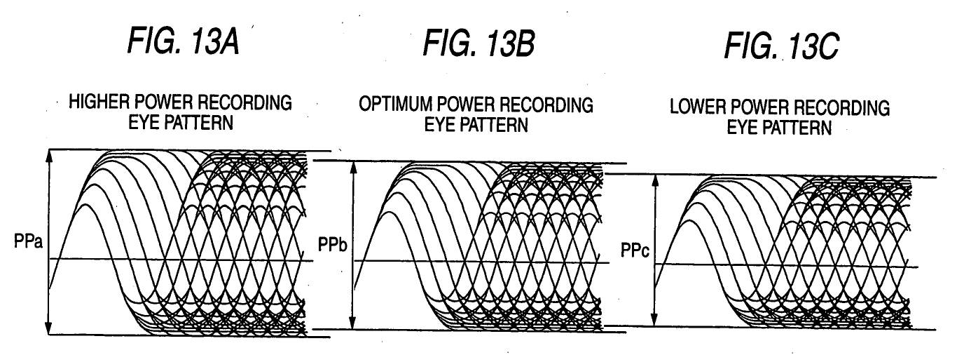

FIGS. 13A to 13C are reproduced signal patterns in which 3T to 11T pits recorded under conditions shown in FIG. 12A are reproduced. This reproduced signal pattern is referred to as an “eye pattern” hereinafter. FIG. 13A shows the eye pattern of the reproduced signal of the pit that is recorded at a recording power higher than the optimum recording power by a strategy shorter than the optimum strategy. FIG. 13B shows the eye pattern of the reproduced signal of the pit that is recorded at the optimum power recording by the optimum strategy. FIG. 13C shows the eye pattern of the reproduced signal of the pit that is recorded at a recording power lower than the optimum recording power by a strategy longer than the optimum strategy. As shown in FIGS. 13A to 13C, it is appreciated that these reproduced signals are equal in all conditions when these eye patterns are sliced along a center wave line, but the PP value as an opening of the eye pattern becomes larger as the recording power is increased larger. That is, the relationship of the PP values of respective eye patterns shown in FIGS. 13A to 13C is given as PPa>PPb>PPc.

Therefore, in the optical disk recording system according to the second embodiment of the present invention, upon overwriting the data on the rewritable optical disk, the optimum recording power is detected by applying the OPC to the rewritable optical disk and then the PP value of the data recorded at the optimum recording power is calculated. The PP value is detected by reproducing the to-be-overwritten old data recorded on the rewritable optical disk, and then this PP value is compared with the PP value of the data recorded at the optimum recording power. As described above, since the PP value has a characteristic such that such PP value is increased larger as the recording power becomes higher, the comparison of the PP value makes it possible to detect the recording power value. In the optical disk recording system according to the second embodiment of the present invention, the PP values (openings of the eye patterns) of both data are compared with each other by utilizing this characteristic, the recording conditions such as the erasing power, the recording power, etc. are changed in response to the compared result (e.g., the recording conditions are changed into the same recording conditions as those of the optical disk recording system by which the old data are recorded) to overwrite the data. As a result, since the old data can be perfectly erased when the data are overwritten by the optical disk recording system that is different from the optical disk recording system by which the old data are recorded, deterioration of the jitter can be prevented and the error rate can be decreased.

As the recording conditions that are changed based on the compared result of a crosstalk amount, upon overwriting the data onto the rewritable optical disk, the erasing power of the laser beam that the optical disk recording system irradiates onto the rewritable optical disk may be changed such that the old data being subjected to the overwrite can be erased surely. The data may be overwritten (erased and recorded) like the original optical disk recording system by changing the conditions such as the recording power, the bottom power (bias power), the ε (erasing power/recording power), the write strategy, the correction value of the recording power obtained by the OPC, etc.

In this case, in case the recording power of the optical disk recording system used to record the old data is weaker than the recording power of the optical disk recording system used to overwrite the data, or the like, the erasing power and the recording power must be increased. Thus, degradation of the rewritable optical disk and the laser diode in the optical disk recording system 1 is accelerated. Therefore, in such case, upon overwriting the data on the rewritable optical disk, the erasing power of the laser beam irradiated onto the rewritable optical disk may be increased in response to the PP value of the old data, and then the data may be overwritten by using the value, which is set in the optical disk recording system as its own initial value, not to change the recording power. As a result, the degradation of the rewritable optical disk and the laser diode in the optical disk recording system 1 can be suppressed.

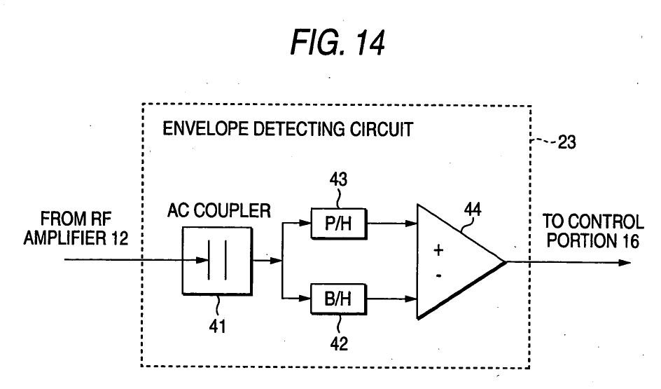

FIG. 14 is a block diagram showing details of the envelope detecting circuit. In the optical disk recording system 1, the PP value of the reproduced signal is detected by the envelope detecting circuit 23. As shown in FIG. 14, the envelope detecting circuit 23 is composed of an AC coupler 41, a bottom hold circuit (B/H) 42, a peak hold circuit (P/H) 43, and a calculating circuit (OP amplifier) 44.

The AC coupler 41 cut off a DC component in the signal output from the RF amplifier 12, and then outputs an AC component to the bottom hold circuit 42 and the peak hold circuit 43. The bottom hold circuit 42 holds a bottom value (a peak value on the low level side) A of the signal output from the AC coupler 41, and then outputs it. The peak hold circuit 43 holds a peak value (a peak value on the high level side) B of the signal output from the AC coupler 41, and outputs it. The calculating circuit 44 executes a calculation by using the bottom value A output from the bottom hold circuit 42 and the peak value B output from the peak hold circuit 43 to calculate the PP value. In the envelope detecting circuit 23, respective circuits for executing the above processes cooperate to detect the PP value of the eye pattern of the reproduced signal of the old data recorded on the rewritable optical disk.

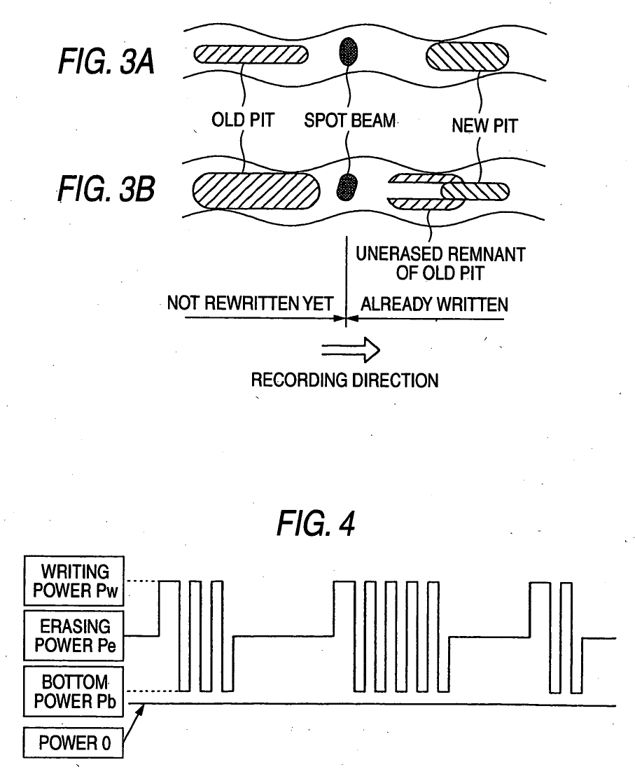

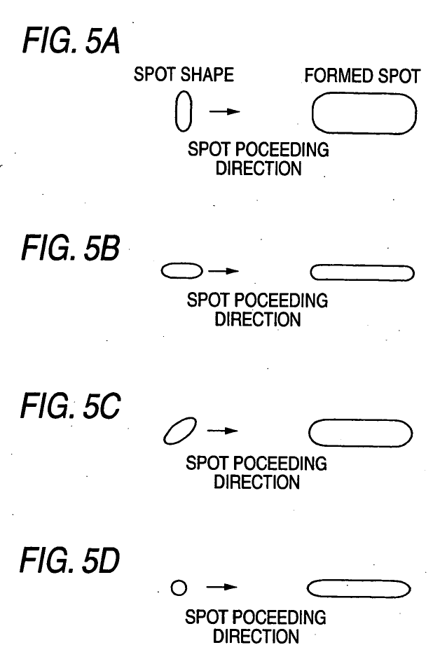

In the optical disk recording system 1, when the data are overwritten, it is checked whether or not the recording power among the recording conditions of the pit on which the data have already been recorded was higher than the optimum recording power. This is because, as explained with reference to FIGS. 3A and 3B, in some cases the old data are not sufficiently erased unless the recording conditions are set properly at the time of overwriting. Therefore, in the optical disk recording system 1, the reproduced signal is obtained by irradiating the light beam at the reproducing power level onto the recording pit of the track as the overwritten object. In the envelope detecting circuit 23, the bottom value is held by the bottom hold circuit 42 and the peak value is held by the peak hold circuit 43 after the reproduced signal output from the RF amplifier 12 passed through the AC coupler 41, and then the PP value (eye pattern opening signal) is calculated based on a difference between these values and output to the control portion 16.

The PP value of the recording area on which the data are recorded at the optimum recording power may be acquired at the time of OPC or may be acquired at another chance. The control portion 16 decides based on the difference between both PP values which one of eye patterns is opened larger, and optimizes the erasing power in response to the difference. If the eye pattern in the area as the overwritten object is large, control to increase the erasing power is executed.

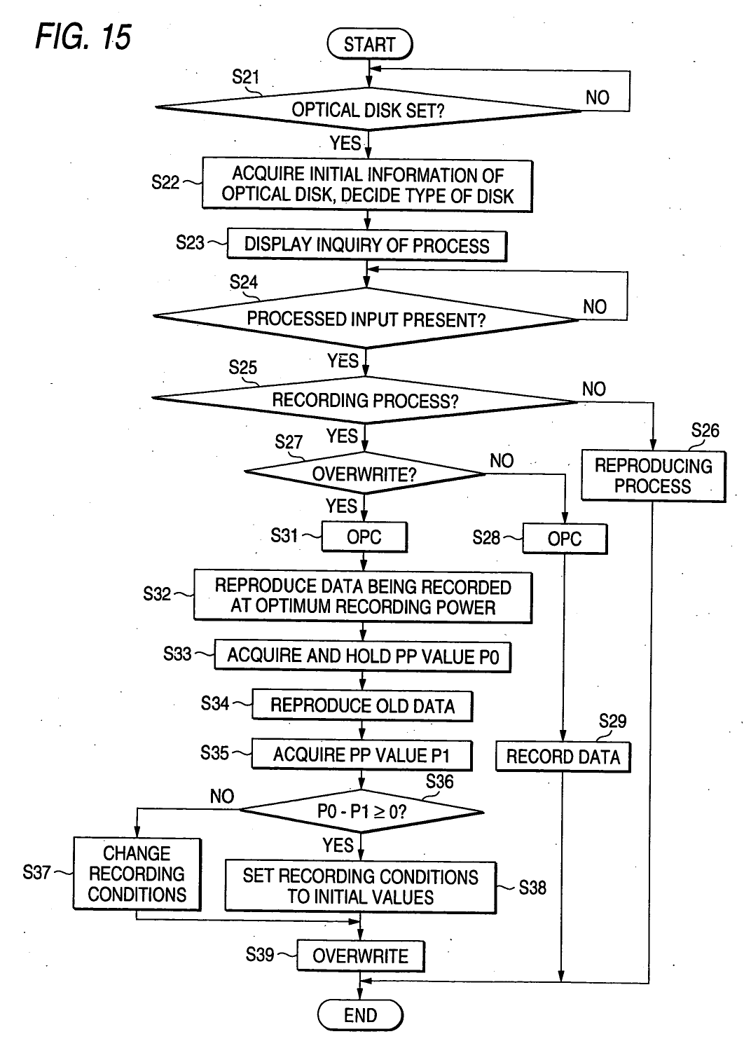

Next, the process applied when an optical disk recording system according to a second embodiment of the present invention overwrites the data on the rewritable optical disk will be explained hereunder. FIG. 15 is a flowchart explaining an operation of detecting the PP value in the optical disk recording system according to the second embodiment.

As shown in FIG. 15, first the user sets the CD-RW on the disk tray of the optical disk recording system 1 in case the data are recorded on the CD-RW. The control portion 16 of the optical disk recording system 1 detects that the optical disk is set (s21), then chucks the CD-RW, then moves the optical pickup up to a predetermined location, and then acquires initial information of the optical disk by irradiating the laser beam (s22). More particularly, first the control portion 16 decides the reflectance of the laser beam to identify the type of the optical disk. At this time, it is possible to decide that the optical disk is the rewritable optical disk (CD-RW) if the reflectance of the optical disk is low, while the optical disk is the write once optical disk (CD-R) or the read only (non-recordable) optical disk (CD-ROM) if the reflectance of the optical disk is high. The control portion 16 detects whether or not a wobble component is present in the lead-in area of the optical disk being set in the optical disk recording system 1, and detects ATIP information if the wobble information is present. The optical disk is decided as the rewritable or write once optical disk if the ATIP information are detected, and then the information such as disk ID (maker code), STLI (Start Time of Lead-In Area: equivalent to the maker code and the disk code), etc. contained in the ATIP information are utilized in various controls. In this manner, the control portion 16 decides which one of the rewritable, write once, and read only optical disks the optical disk corresponds to, based on the reflectance and the ATIP information. The control portion 16 acquires the disk ID of the optical disk from the ATIP information.

Then, the control portion 16 displays the contents inquiring the processes applied to the CD-RW being set by the user, on the display portion 28 (s23). The user inputs the processes that are to be applied to the set CD-RW, in answer to this display. If the control portion 16 detects the input from the operating portion 27 (s24) and if reproduction of the data is set (s25), such control portion 16 carries out the data reproducing process (s26). The control portion 16 ends the process when the reproduction of the data is completed.

In contrast, if the recording of the data is set (s25), the control portion 16 decides that the recording operation is either the initial recording or the overwriting (s27). More specifically, the control portion 16 decides whether or not the EFM signal is present in the lead-in area and PMA, and then decides such recording operation as the initial recording if the EFM signal is not recorded in both areas or the lead-in area. In case the CD-RW is a blank disk or in the course of recording, the data are recorded for the first time in an unrecorded area of the optical disk D. Thus, the control portion 16 decides the optimum recording power by executing the OPC in PCA (s28). Then, the control portion 16 records the data or writes once the data on the CD-RW (s29), and then ends the process.

In contrast, in step s27, if the EFM signal is recorded in the lead-in area and the PMA of the CD-RW, the control portion 16 decides that the overwriting should be executed and first decides the optimum recording power by executing the OPC (s31). More specifically, the trial writing is executed in the PCA of the CD-RW at 15 power levels by repeating a predetermined power increment. Then, trial-written data are reproduced and then the reproduced signal is output to the reproduced-signal quality detecting circuit 24 to calculate the β value. Then, the power level used to record the area in which this β value is closest to a predetermined value is selected as the optimum recording power level.

Then, the control portion 16 of the optical disk recording system 1 reproduces the data recorded at the optimum recording power (s32), then acquires a PP value P0 output from the envelope detecting circuit 23, and then holds (stores) it temporarily (s33). The control portion 16 reproduces the old data recorded on the rewritable optical disk (s34), and then acquires a PP value P1 output from the envelope detecting circuit 23 (s35). Then, the control portion 16 calculates a difference between the PP value P0 and the PP value P1, and then optimizes the erasing power in answer to this difference. In the case of P0−P1<0, the control portion 16 changes the recording conditions. For example, since the old data have the large recording power, the control portion 16 sets the erasing power to a predetermined value that is larger than the reference value (s37). Then, the control portion 16 overwrites the data on the rewritable optical disk by applying this corrected erasing power (s39), and then ends the process when the recording of the data is completed.

In contrast, in the case of P0−P1≧0, the control portion 16 sets the recording conditions to initial values set in the optical disk recording system 1. That is, the control portion 16 sets the erasing power and the recording power to the reference erasing power P0e and the reference recording power P0w (s38), then overwrites the data on the rewritable optical disk (s39), and then ends the process when the recording of the data is completed.

With the above, the case where the recording medium is the CD-RW is explained. The present invention is applicable to the DVD−RW and the DVD+RW.

According to the present invention, following advantages can be achieved.

(1) The data are overwritten according to the recording conditions in conformity with the reproduced signal of the old data recorded on the rewritable optical disk. Therefore, the old data can be perfectly erased and the newly overwritten data can be reproduced without the influence of the old data.

(2) A crosstalk amount is increased as the recording power irradiated onto the rewritable optical disk is enhanced and thus a width of the pit is thickened. Therefore, the recording power value applied to the old data can be presumed by comparing crosstalk amounts.

(3) A difference between a crosstalk amount detected from the reproduced signal of the data recorded on the rewritable optical disk and a reference crosstalk amount is calculated. Therefore, it can be grasped at what power level with respect to the reference recording power (optimum recording power) the old data were recorded.

(4) A value of the crosstalk amount is detected from the reproduced signal by reproducing the test data recorded at the optimum recording power, and then this value is used as a reference crosstalk amount. Therefore, even in the newly sold rewritable optical disk, the recording conditions that are optimum to the rewritable optical disk can be decided quickly without update of the firmware, etc.

(5) A peak-to-peak value of the amplitude of the data recorded on the rewritable optical disk is increased as the recording power irradiated onto the rewritable optical disk is enhanced and thus the width of the pit is thickened. Therefore, the recording power value of the old data can be presumed on the basis of the peak-to-peak value of the amplitude of the reproduced signal.

(6) A peak-to-peak value of the amplitude is detected by reproducing the old data recorded on the rewritable optical disk, and then the peak-to-peak value of this amplitude is compared with the peak-to-peak value of the amplitude of the data recorded at the optimum recording power. Therefore, the recording power value of the old data can be presumed.

(7) Differences in the recording conditions between the old data and the to-be-overwritten data can be detected by detecting the difference between the peak-to-peak value of the reproduced signal of the old data recorded on the rewritable optical disk and the peak-to-peak value of the data recorded at the optimum recording power. Therefore, if the erasing power is corrected in response to the differences, the old data can be perfectly erased and the to-be-overwritten data can be recorded under the optimum recording conditions.

What is claimed is:

1. An optical disk recording method comprising:
deriving a recording condition of old data recorded on a rewritable optical disk by reproducing the old data or from a reproduced waveform;
deciding an overwriting recording condition to overwrite new data on the old data recorded under the recording condition of the old data; and
overwriting the new data on the old data according to the decided overwriting recording condition.

2. The optical disk recording method according to claim 1, wherein the recording condition of the old data is derived upon an instruction to overwrite the new data on old data recorded on the rewritable optical disk.

3. An optical disk recording method comprising:
detecting a crosstalk amount from a reproduced signal of old data recorded on a rewritable optical disk;
setting a recording condition based on the detected crosstalk amount; and
overwriting new data according to the recording condition.

4. The optical disk recording method according to claim 3, wherein the crosstalk amount is detected upon an instruction to overwrite the new data on old data recorded on the rewritable optical disk.

5. The optical disk recording method according to claim 3, wherein the recording condition is set in response to a difference between the detected crosstalk amount and a reference crosstalk amount.

6. The optical disk recording method according to claim 5, wherein an optimum recording power is decided by applying a trial writing onto a trial writing area of the rewritable optical disk, and the reference crosstalk amount is detected based on a reproduced signal of data that are recorded at the optimum recording power.

7. An optical disk recording method comprising:
acquiring a peak-to-peak value of a reproduced signal of old data recorded on a rewritable optical disk;
setting a recording condition based on the peak-to-peak value; and
overwriting new data according to the recording condition.

8. The optical disk recording method according to claim 7, wherein the peak-to-peak value is acquired upon an instruction to overwrite the new data on old data recorded on the rewritable optical disk.

9. The optical disk recording method according to claim 7, wherein an optimum recording power is decided by applying a trial writing onto a trial writing area of the rewritable optical disk, and the recording condition is set in response to a difference between the peak-to-peak value of the reproduced signal of data recorded at the optimum recording power and the peak-to-peak value of the reproduced signal of the old data.

10. An optical disk recording method comprising:
applying a trial writing while changing a laser power irradiated onto a trial writing area ofa rewritable optical disk by a predetermined amount;
deciding an optimum recording power based on a reproduced signal of trial-written data;
acquiring a first peak-to-peak value based on a peak value and a bottom value of a reproduced signal of data recorded at the optimum recording power;
acquiring a second peak-to-peak value based on a peak value and a bottom value of a reproduced signal of old data recorded on the rewritable optical disk; and
correcting an erasing power of a laser beam irradiated onto the rewritable optical disk in response to a difference between the first and second peak-to-peak values, and overwriting the new data by applying a corrected erasing power.

11. The optical disk recording method according to claim 10, wherein the trial writing is applied upon an instruction to overwrite the new data on old data recorded on the rewritable optical disk.

12. An optical disk recording system comprising:
a reproducing unit which reproduces data recorded on a rewritable optical disk;
a crosstalk detecting unit which detects a crosstalk amount from a reproduced signal of the reproducing unit;
a recording-condition setting unit which sets a recording condition based on the crosstalk amount detected by the crosstalk detecting unit; and
a recording unit which overwrites new data on old data according to the recording condition set by the recording-condition setting unit.

13. An optical disk recording system comprising:
a reproducing unit which reproduces data recorded on a rewritable optical disk;
an envelope detecting unit which acquires a peak-to-peak value of a reproduced signal of the reproducing unit;
a recording-condition setting unit which sets a recording condition based on the peak-to-peak value acquired by the envelope detecting unit; and
a recording unit which overwrites new data on old data according to the recording condition set by the recording-condition setting unit.
